(19) United States
(12) Patent Application Publication
(10) Pub. No.: US 2020/0070241 A1
(43) Pub. Date: Mar. 5, 2020

(54) MAGNETIC POWDER AND MAGNET

(71) Applicant: DENSO CORPORATION, Kariya-city (JP)

(72) Inventors: Yuta SAIGA, Kariya-city (JP); Sho GOTO, Kariya-city (JP); Ryota SHINOZAKI, Kariya-city (JP); Hiroaki KURA, Kariya-city (JP); Eiji WATANABE, Kariya-city (JP)

(21) Appl. No.: 16/677,755

(22) Filed: Nov. 8, 2019

Related U.S. Application Data
(63) Continuation of application No. PCT/JP2018/018359, filed on May 11, 2018.

(30) Foreign Application Priority Data
May 16, 2017 (JP) 2017-097348
Apr. 3, 2018 (JP) 2018-071511

(51) Int. Cl. B22F 1/00; H01F 1/047; C08K 9/02; C08K 3/08; B22F 1/02; C22C 19/03

(52) U.S. Cl. CPC B22F 1/0011; H01F 1/047; C08K 9/02; H02K 1/02; B22F 1/02; C22C 19/03; C08K 3/08

(57) ABSTRACT

A magnetic powder is provided. The magnetic powder includes a main body portion including an L10-FeNi. The magnetic powder further includes an oxide layer formed on a surface of the main body portion. A magnet is also provided. The magnet includes a base material. The magnet further includes the magnetic powder dispersed in the base material.

### CROSS REFERENCES TO RELATED APPLICATIONS

The present application is a continuation application of international patent application No. PCT/JP2018/018359 filed on May 11, 2018, which designated the U.S. and claims the benefit of priorities from Japanese Patent Application No. 2017-097348 filed on May 16, 2017 and Japanese Patent Application No. 2018-071511 filed on Apr. 3, 2018. The entire disclosures of all of the above applications are incorporated herein by reference.

### TECHNICAL FIELD

The present disclosure relates to a magnetic powder and a magnet.

### BACKGROUND

There is known a rare earth bonded magnet. The rare earth bonded magnet includes a base material and a rare earth magnetic powder dispersed in the base material. The rare earth bonded magnet is excellent in magnetic property, flexibility in molding, dimensional stability, and the like. The rare earth bonded magnet is used in various motors and actuators for automobiles.

However, detailed studies by the inventors found that the rare-earth bonded magnet has such a disadvantage that the magnetic property is deteriorated in a high temperature environment. A conjectured reason for the magnetic property deterioration is that a surface of the rare earth magnetic powder is oxidized in a high temperature environment.

### SUMMARY

The present disclosure provides a magnetic powder and a magnet.

In one aspect of the present disclosure, a magnetic powder comprises: a main body portion comprising an L10-FeNi and an oxide layer formed on a surface of the main body portion. This magnetic powder may be less likely to deteriorate in magnetic property even in a high temperature environment.

In another aspect of the present disclosure, a magnet comprises a base material and the above magnetic powder dispersed in the base material. This magnet may be less likely to have a deteriorated magnetic property even in a high temperature environment.

### BRIEF DESCRIPTION OF DRAWINGS

FIG. 1 is a cross-sectional view illustrating a structure of a magnetic powder.

FIG. 2 is a cross-sectional view illustrating a structure of a magnet.

FIG. 3 is a graph showing a relationship between heat treatment temperature and oxide layer thickness.

FIG. 4 is a chart showing XRD patterns of a magnetic powder before and after a heat treatment.

FIG. 5 is a TEM image used in measuring particle size of a magnetic powder.

FIG. 6 is a TEM image used in measuring oxide layer thickness.

FIG. 7 is a graph showing a relationship between measured temperature and normalized Mr value.

FIG. 8 is a graph showing a relationship between measured temperature and normalized Hc value.

FIG. 9 is a chart showing an XRD pattern of a magnetic powder 1D.

FIG. 10 is a chart showing an XRD pattern of a magnetic powder 1A.

FIG. 11 is diagram illustrating a hysteresis curve representing magnetic property of magnetic powder when an oxide layer contains an antiferromagnetic material.

### DETAILED DESCRIPTION

Illustrative embodiments of the present disclosure will be described with reference to the drawings.

### 1. Structure Magnetic Powder

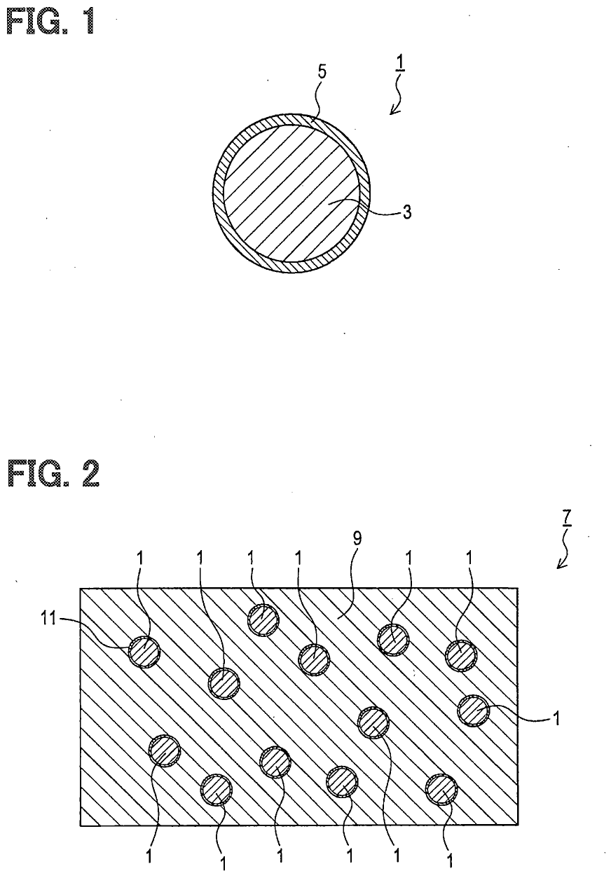

As shown in FIG. 1, a magnetic powder 1 includes: a main body 3 containing L10-FeNi; and an oxide layer 5 formed on a surface of the main body 3. The magnetic powder 1 is unlikely to deteriorate in magnetic property even in a high temperature environment. Examples of magnetic property include residual magnetization Mr and coercivity Hc.

The L10-FeNi means FeNi having an L10 structure. A shape of the main body 3 is not particularly limited. Examples of the shape of the main body 3 include a spherical shape and an irregular shape. The particle size of the magnetic powder 1 is preferably in a range of 30 nm to 10 μm, and more preferably in a range of 30 nm to 5 μm. When the particle size of the magnetic powder 1 is 30 nm or more, the coercivity of the magnetic powder 1 is further increased. When the particle size of the magnetic powder 1 is 10 μm or less, the coercivity of the magnetic powder 1 is further increased. Moreover, when the particle size of the magnetic powder 1 is 10 μm or less, the degree of flexibility in molding of the magnet including the magnetic powder 1 is further improved. A method of measuring the particle size of the magnetic powder 1 is as follows.

A TEM image representing a set of the magnetic powder particles 1 is acquired. Ten magnetic powder particles 1 are arbitrarily extracted from the TEM image. The particle sizes of respective ten extracted magnetic powder particles 1 are measured. A value obtained by averaging the particle diameters of the ten magnetic powder particles 1 is defined as the particle size of the magnetic powder 1. FIG. 5 shows an example of a TEM image. In FIG. 5, the portion marked with a circle is the extracted magnetic powder particles 1.

The thickness of the oxide layer 5 is preferably 0.83 nm or more and 5.0 nm or less. 0.83 nm corresponds to an interval of crystal lattices of the oxide constituting the oxide layer 5. When the thickness of the oxide layer 5 is 0.83 nm or more, oxidation of the main body 3 is further suppressible. When the thickness of the oxide layer 5 is 5.0 nm or less, oxidation of the main body 3 is further suppressible, and residual magnetization of the magnetic powder 1 is further increased. A method of measuring the thickness of the oxide layer 5 is as follows. A TEM image representing a set of magnetic powder particles 1 is acquired. In the TEM image, five magnetic powder particles 1 are extracted. In a respective magnetic powder particle 1, the thicknesses of the oxide layer 5 at four arbitrarily selected points are measured. The average value of the thicknesses of the oxide layer 5 at 20 points in total are assumed to be the thickness of the oxide layer 5.

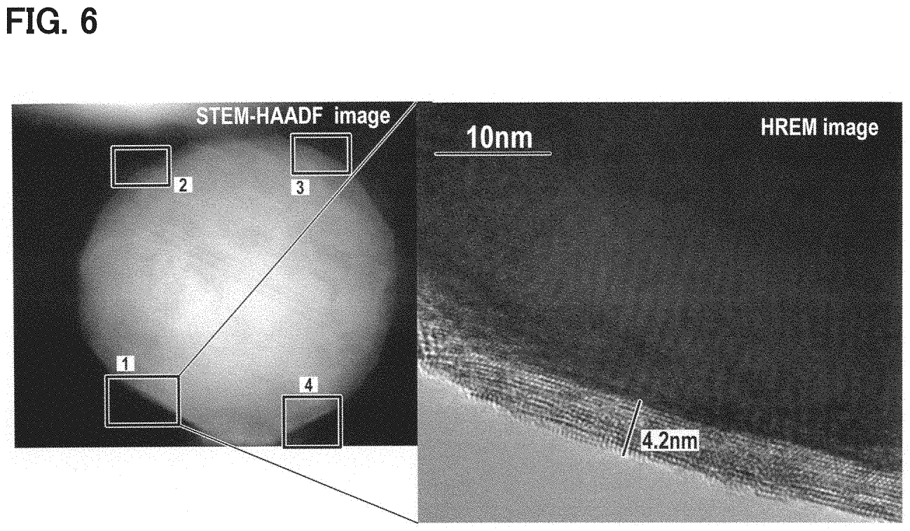

FIG. 6 shows an example of a TEM image. The left part in FIG. 6 represents one magnetic powder particle 1. Rectangular frames numbered 1 to 4 represent portions where the thickness of the oxide layer 5 is measured. The right part in FIG. 6 represents the inside of a frame numbered 1. 4.2 nm means the thickness of the oxide layer 5 within the frame numbered 1. As shown in the right part in FIG. 6, in the TEM image, the oxide layer 5 is identifiable by the brightness of the image.

It is preferable that the oxide layer 5 contains NiₓFe₍₃₋ₓ₎O₄. The value of x is 0 or more and 3 or less. When the oxide layer 5 contains NiₓFe₍₃₋ₓ₎O₄, the magnetic property of the magnetic powder 1 is more unlikely to deteriorate even in a high temperature environment.

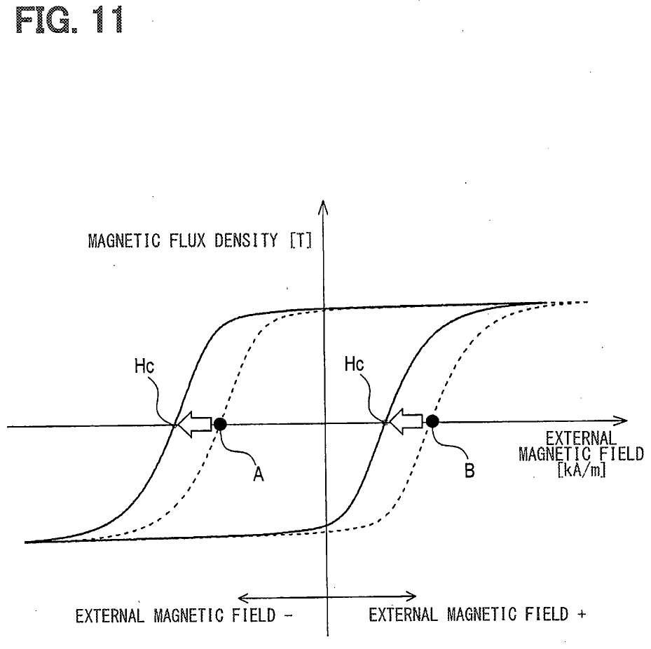

It is preferable that the oxide layer 5 contains an antiferromagnetic material. FIG. 11 shows the magnetic property of the magnetic powder when the oxide layer 5 contains an antiferromagnetic material. When the oxide layer 5 contains an antiferromagnetic material, the magnetic powder coercivity Hc in a negative external magnetic field increases, and the magnetic powder coercivity Hc in a positive external magnetic field decreases.

Note that A in FIG. 11 is the coercivity of the magnetic powder having a natural oxide film as the oxide layer 5 under a negative external magnetic field. B is the coercivity of the magnetic powder having a natural oxide film as the oxide layer 5 under a positive external magnetic field.

A conjectured reason for increasing the magnetic powder coercivity Hc in a negative external magnetic field in the cases of the oxide layer 5 containing an antiferromagnetic material is that an exchange magnetic anisotropy generates at an interface between the antiferromagnetic material contained in the oxide layer 5 and the L10-FeNi contained in the main body 3 and the direction of the magnetic moment of the L10-FeNi is maintained. It is more preferable that the oxide layer 5 contains an antiferromagnetic material as its main component.

When the oxide layer 5 contains an antiferromagnetic material, a small magnetic may provide the magnetic powder with positive magnetization. When the oxide layer 5 contains an antiferromagnetic material, it is possible to stabilize permanent magnet performance due to difficult reverse against negative magnetic field.

Moreover, when the oxide layer 5 contains an antiferromagnetic material, environment resistance and durability of the oxide layer are further increased. When the oxide layer 5 contains an antiferromagnetic material, eddy loss due to induced electromotive force caused by a change in the external magnetic field is reducible. This is because electrical conductivity of an antiferromagnetic material such as NiO is comparable to that of a semiconductor.

In the XRD measurement results of the magnetic powder, a peak area (111) originating from the antiferromagnetic material is S1, and a peak area (311) originating from NiₓFe₍₃₋ₓ₎O₄ is S2. The ratio of S1 to S2 is S1/S2. The ratio S1/S2 is preferably greater than 0.27. When the ratio S1/S2 is greater than 0.27, the magnetic powder coercivity Hc in a negative external magnetic field is further increased. The more the antiferromagnetic materials contained in the oxide layer, the larger the ratio S1/S2 is.

When the oxide layer is a natural oxide film, the ratio S1/S2 is 0.27 or less. The reason is as follows. The mass ratio of Fe to Ni in the FeNi particle is 1:1. Therefore, the molar ratio of NiFe₂O₄ and NiO when the molar ratio of NiO is maximized in the natural oxide film is 1:1. When the molar ratio of NiFe₂O₄ and NiO is 1:1, the ratio S1/S2 is 0.27. Therefore, when the oxide layer is a natural oxide film, the ratio S1/S2 is 0.27 or less.

Note that the (222) peak angle originating from NiₓFe₍₃₋ₓ₎O₄ is close to the (111) peak angle originating from NiO. Therefore, in cases where the (222) peak originating from NiₓFe₍₃₋ₓ₎O₄ is observed, when the (111) peak area S1 originating from NiO is calculated, it is desirable to subtract the contribution of the (222) peak originating from NiₓFe₍₃₋ₓ₎O₄.

The Neel temperature of at least a part of the antiferromagnetic material is preferably 273 K or higher. When the Neel temperature of at least a part of the antiferromagnetic material is 273 K or higher, the coercivity Hc of the magnetic powder 1 in a negative external magnetic field is further increased at a temperature higher than room temperature.

Examples of the antiferromagnetic material include one or more materials selected from the group consisting of NiO, CoO, Cr₂O₃, Fe₂O₃, CuFeS₂, FeF₂, Cr, AuMn, MnPt, MnPd, γFeMn, and γIrMn. When the antiferromagnetic material is any of these materials, the coercivity Hc of the magnetic powder 1 in a negative external magnetic field is further increased.

When the oxide layer 5 contains an antiferromagnetic material, the thickness of the oxide layer is preferably 1 nm or more. When the thickness of the oxide layer is 1 nm or more, the coercivity Hc of the magnetic powder 1 in a negative external magnetic field is further increased.

### 2. Magnet Structure

As shown in FIG. 2, the magnet 7 comprises a base material 9 and the magnetic powder 1 dispersed in the base material 9. The magnet 7 is a bonded magnet. The magnet 7 is unlikely to deteriorate in magnetic property even in a high temperature environment. Examples of the magnetic property include residual magnetization Mr and coercivity Hc.

The base material 9 contains, for example, a resin. When the base material 9 contains a resin, the magnet 7 has a high degree of flexibility in molding and dimensional stability. As the resin, a resin having a glass transition temperature of 100 degrees Celsius or higher is preferable. When the base material 9 contains a resin having a glass transition temperature of 100 degrees Celsius or higher, the strength of the magnet 7 at a high temperature is further increased. Examples of the resin having a glass transition temperature of 100 degrees Celsius or higher include epoxy, phenol, polyester, polyimide, and polyamide. All of the base material 9 may be a resin, or a part of the base material 9 may be a resin. As the resin, a thermosetting resin is preferable. Examples of the thermosetting resin include an epoxy type and a phenol type.

Assuming that the total volume of the magnet 7 is 100 vol %, the volume ratio of the magnetic powder 1 is preferably 50 to 80 vol %. When the volume ratio of the magnetic powder 1 is 50 vol % or more, the magnetic property of the magnet 7 is further improved. When the volume ratio of the magnetic powder 1 is 80 vol % or less, the magnet 7 can be manufactured more easily.

It is preferable that the magnet 7 further comprises an organometallic compound having a functional group. The organometallic compound may be selectively present at the interface 11 between the magnetic powder 1 and the base material 9, or may be present throughout the base material 9.

The SP value of the resin contained in the base material is defined as SP1. The SP value of the organometallic compound having a functional group is defined as SP2. X represented by the following expression (1) is preferably in a range of −0.25 to 0.25. The SP value is an estimated value by the Fedors method.

X=(SP1−SP2)/SP1 (Expression 1).

When X is in the range of −0.25 to 0.25, the dispersibility of the magnetic powder 1 in the base material 9 and the adhesion between the magnetic powder 1 and the base material 9 are further improved. Examples of the functional group include an epoxy group and an amino group. Examples of the organometallic compound include 3-glycidoxypropyltrimethoxysilane, 3-glycidoxypropylmethyldimethoxysilane, 4-aminophenyltrimethoxysilane, and the like. Examples of the metal contained in the organometallic compound include Si, P, Al, Ti, and Zr.

The metal contained in the organometallic compound is conjectured to have covalent bonding to the oxide layer included in the magnetic powder. Moreover, the functional group contained in the organometallic compound is conjectured to exist in the base material. When the total mass of the magnetic powder 1 is 100 mass %, the mass ratio of the organometallic compound is preferably 0.1 to 10 mass %. When the mass ratio of the organometallic compound is in a range of 0.1 mass % to 10 mass %, the dispersibility of the magnetic powder 1 in the base material 9 and the adhesion between the magnetic powder 1 and the base material 9 are further improved.

### 3. Formation of Oxide Layer in Magnetic Powder

When the L10-FeNi particles are heat-treated at 150 degrees Celsius to 200 degrees Celsius, an oxide layer is formed on its surface. As a result, a magnetic powder comprising: a main body portion containing L10-FeNi; and an oxide layer formed on the surface of the main body portion is manufactured.

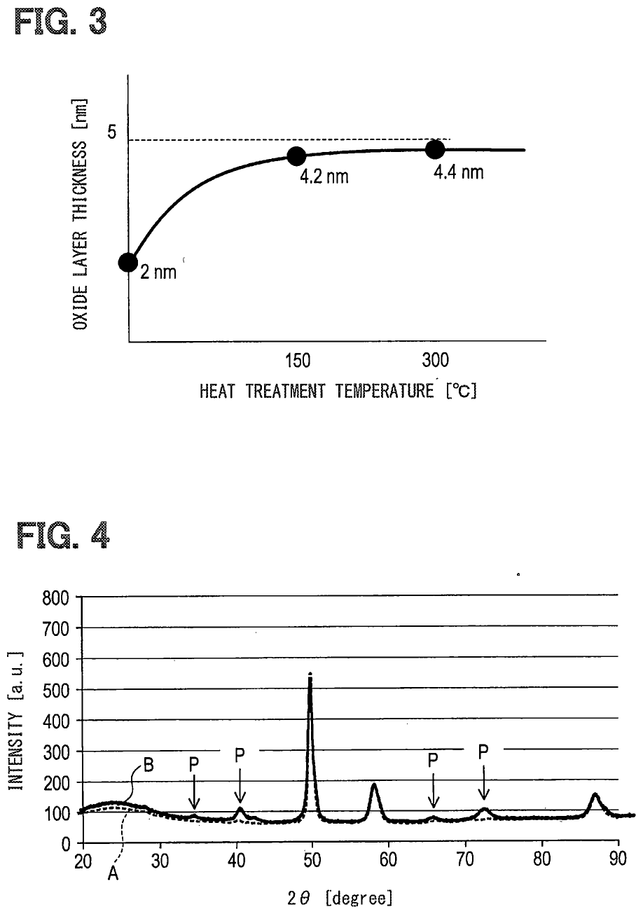

The heat treatment may be performed, for example, on a kneaded product of L10-FeNi particles and a resin. Alternatively, the heat treatment may be performed in a state where the L10-FeNi particles exist alone. FIG. 3 shows the relationship between the heat treatment temperature and the thickness of the oxide layer. When the heat treatment temperature is set to 150 degrees Celsius to 200 degrees Celsius, the thickness of the oxide layer is substantially saturated. The saturation thickness is about 5 nm.

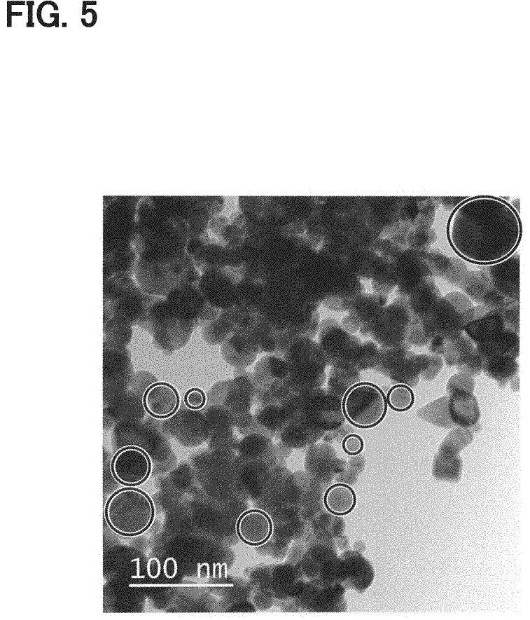

FIG. 4 shows an XRD pattern of the magnetic powder before the heat treatment (hereinafter referred to as pre-treatment pattern A) and an XRD pattern of the magnetic powder after the heat treatment at 300 degrees Celsius (hereinafter referred to as post-treatment pattern B). The XRD pattern shown in FIG. 4 is obtained using powder X-ray diffraction of the beam line BL5S2 of “Aichi Synchrotron Radiation Center”. In the pre-treatment pattern A, there is no peak P indicating the presence of NixFe3-xO4 (x˜1.5). The post-treatment pattern B has a peak P indicating the presence of NixFe3-xO4 (x˜1.5). This confirmed that the oxide layer was generated by the heat treatment, and that the oxide layer contained NiₓFe₃₋ₓO₄ (x˜1.5).

Note that the oxide layer formed by performing the heat treatment as described above is a natural oxide film. An oxide layer containing an antiferromagnetic material as its main component may be formed as follows. First, the natural oxide film formed on the surface of the main body 3 is removed. As a method for removing the natural oxide film, for example, a method of performing a heat treatment at a high temperature in a hydrogen atmosphere may be used. As the method of removing the natural oxide film, for example, a method of immersing in an acid aqueous solution may be used. Examples of the acid include nitric acid and the like.

After removing the natural oxide film, the main body 3 is placed in a nickel hydroxide solution. At this time, the oxide layer containing NiO as its main component is formed on the surface of the main body 3. The oxide layer containing NiO as its main component may be formed by an electrochemical method shown in working example 2 described later.

### 4. Working Example 1

(4-1) Method of producing L10-FeNi particles

As a raw material, FeNi disordered alloy powder was prepared. This FeNi disordered alloy powder is a special-order product made by Nissin Engineering Co., Ltd. manufactured by a thermal plasma method. The composition ratio in the FeNi disordered alloy powder is Fe:Ni=50:50. The unit of the composition ratio is mol %. The average particle size of the FeNi disordered alloy powder is 60 nm.

In order to make the structure of the FeNi disordered alloy powder an L10 structure, nitriding and denitrification treatments were performed. A specific procedure of the nitriding and denitrification treatments is as follows. The FeNi disordered alloy powder was placed on a sample boat. The sample boat was installed in a tubular furnace. Ammonia gas and hydrogen gas were introducible into the tubular furnace. The atmosphere of the tubular furnace was the ammonia gas, and the nitriding treatment was performed at 350 degrees Celsius for 50 hours.

Next, the atmosphere of the tubular furnace was replaced with the hydrogen gas, and the denitrification treatment was performed at 300 degrees Celsius for 2 hours. Next, after cooling the tubular furnace, the sample boat was taken out of the tubular furnace. As a result, the L10-FeNi particles were obtained. The L10-FeNi particles are FeNi particles having an L10 structure.

(4-2) Magnet manufacturing method

Surface modification with 4-aminophenyltrimethoxysilane was performed on the surface of the L10-FeNi particles obtained in (4-1). A purpose of the surface modification is to improve the affinity and adhesion between the L10-FeNi particles and the resin. The 4-Aminophenyltrimethoxysilane corresponds to an organometallic compound. The 4-Aminophenyltrimethoxysilane is a kind of silane coupling agent solution. The SP value of the 4-aminophenyltrimethoxysilane is 10.2.

A specific method of the surface modification was as follows. An aqueous alcohol solution was added to the L10-FeNi particles to prepare a slurry solution. The aqueous alcohol solution has a mass ratio of water/ethanol of 1/9. The 4-Aminophenyltrimethoxysilane was added to the slurry. An amount of the 4-aminophenyltrimethoxysilane added is 1 mass % of the L10-FeNi particles contained in the slurry liquid. After the addition of the 4-aminophenyltrimethoxysilane, the slurry was stirred with ultrasound for 3 minutes and then allowed to stand for 10 minutes. Next, the surface-modified L10-FeNi particles were taken out from the slurry liquid by filtration. The taken out L10-FeNi particles were spread on a shallow tray and dried for 30 minutes.

Next, the surface-modified L10-FeNi particles and the epoxy resin were kneaded using a stirrer to obtain a kneaded product. The volume ratio of the L10-FeNi particles in the kneaded product is 60 vol %, and the volume ratio of the epoxy resin was 40 vol %. The epoxy resin was EXP955 made by 3M. The SP value of the epoxy resin was 10.9. The heat resistance temperature of the epoxy resin was 180 degrees Celsius. The glass transition temperature of the epoxy resin was 195 degrees Celsius. The epoxy resin corresponds to a base material. The stirrer was a filmix model 30-30 made by PRIMIX Corporation.

Next, the kneaded material was introduced into a prismatic mold having a size of 1 cm×1 cm×5 cm. Next, while applying a pressure of 64 MPa and a magnetic field of 2 T, the epoxy resin was cured at a temperature of degrees Celsius to complete the magnet. When the epoxy resin is cured, an oxide layer is formed on the surface of the L10-FeNi particles. As a result, the magnetic powder comprising: the main body portion containing the L10-FeNi particles; and the oxide layer formed on the surface of the main body portion is generated. In the magnet, the magnetic powder is dispersed in the epoxy resin.

(4-3) Magnet evaluation

The particle size of the magnetic powder contained in the magnet produced in (4-2) was measured by the method described above. The particle size of the magnetic powder was 60 nm. The thickness of the oxide layer provided in the magnetic powder contained in the magnet produced in (4-2) was measured by the method described above. The thickness of the oxide layer was 5 nm. An XRD pattern of the oxide layer provided in the magnetic powder contained in the magnet manufactured in (4-2) was obtained. In the XRD pattern, there was a peak P indicating the presence of NiₓFe₃₋ₓO₄ (x˜1.5).

The coercivity Ch. and the residual magnetization Mr of the magnet manufactured in the above (4-2) were measured. For the measurement, a small refrigerant-free PPMS VersaLab made by Quantum Design Inc. and a heater option were used. In the measurement, the magnetic field sweep rate was 10 Oe/s. The shape of the measurement sample was a cube of approximately 3 mm×3 mm×3 mm.

First, a sufficiently large magnetic field was applied to the measurement sample to saturate the magnetization of the measurement sample. The magnetic field at this time was 50000 Oe, for example. Next, the applied magnetic field was gradually decreased, and the magnitude of the magnetization of the measurement sample when the applied magnetic field became zero was defined as the residual magnetization Mr.

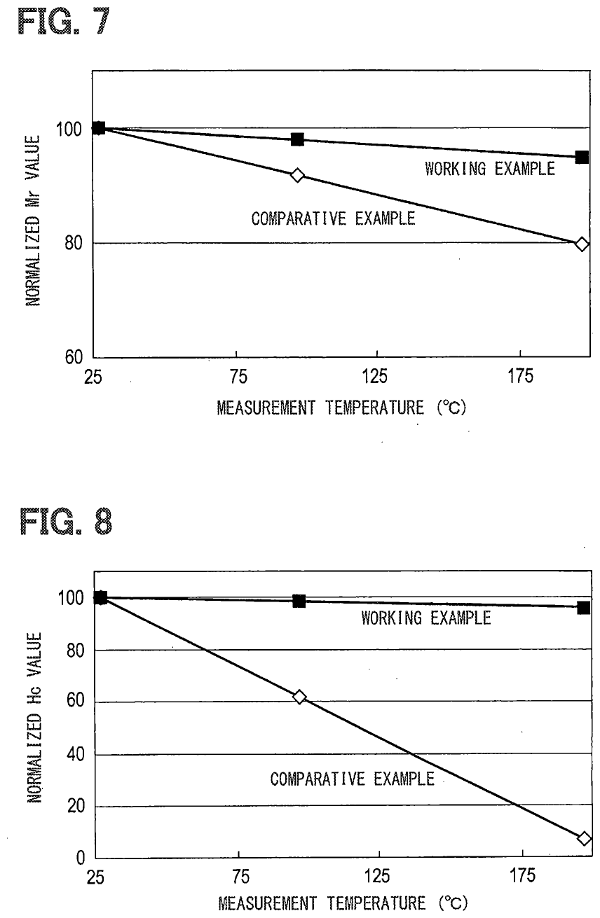

Next, a magnetic field in the opposite direction to the above was applied to the measurement sample, and the applied magnetic field was gradually increased. The strength of the applied magnetic field when the magnetization of the measurement sample became zero was defined as the coercivity Hc. Using the heater option, the magnet coercivity Hc and the residual magnetization Mr were measured by the above method while changing the temperature of the measurement sample. Moreover, the same measurement was performed also about the Nd bonded magnet by Neomag Co., Ltd. as a comparative example. The measurement results are shown in FIGS. 7 and 8. The vertical axis in FIGS. 7 and 8 represents a normalized value. The normalized value means a value normalized by 100 that is the value at 27 degrees Celsius.

The magnet manufactured in (4-2) was less likely to have lower coercivity Hc and the residual magnetization Mr even in a high temperature environment than Nd bonded magnets.

### 5. Working Example 2

(5-1) Production of magnetic powder 1A

In the same manner as in the working example 1, the L10-FeNi particles were obtained. The average particle size of the L10-FeNi particles was 500 nm. The L10-FeNi particles were left in the atmosphere at degrees Celsius for 1 hour. At this time, an oxide layer was formed on the surface of the L10-FeNi particles. This oxide layer was a natural oxide film. Through the above steps, a magnetic powder comprising: a main body portion containing L10-FeNi particles; and an oxide layer formed on the surface of the main body portion was manufactured. Hereinafter, this magnetic powder is referred to as magnetic powder 1A.

(5-2) Manufacture of magnetic powder 1B

The magnetic powder 1A was subjected to a heat treatment at a temperature of 400 degrees Celsius for 1 hour in an atmosphere of 100% hydrogen. By this heat treatment, the oxide layer was reduced and removed, and the magnetic powder without the oxide layer was obtained.

Next, the magnetic powder without the oxide layer was immersed in an aqueous nickel hydroxide solution for 1 hour. The concentration of nickel hydroxide in the aqueous nickel hydroxide solution is 0.1 mass %. The temperature of the nickel hydroxide aqueous solution was a room temperature. An incomplete NiO film was formed on the surface of the L10-FeNi particles by the treatment of immersing in the nickel hydroxide aqueous solution.

Next, the magnetic powder was subjected to a heat treatment in a magnetic field for 1 hour under a constant oxygen concentration. The oxygen concentration was about 0.01 mass %. The strength of the magnetic field was 9 T. The temperature of the heat treatment was 400 degrees Celsius. This heat treatment improved the crystallinity of the NiO film. In addition, this heat treatment developed an exchange coupling force at the interface between the NiO film and the L10-FeNi particles.

Through the above steps, the magnetic powder comprising: the main body portion containing the L10-FeNi particles; and the oxide layer formed on the surface of the main body portion was manufactured. Hereinafter, this magnetic powder is referred to as a magnetic powder 1B. The oxide layer included in the magnetic powder 1B was mainly made of NiO.

(5-3) Manufacture of magnetic powder 1C

A magnetic powder 1C was manufactured in basically the same manners as the manufacturing method of the magnetic powder 1B. However, as a method of removing the oxide layer of the magnetic powder 1A, a method of immersing the magnetic powder 1A in an aqueous nitric acid solution for 10 hours was adopted. The concentration of the nitric acid aqueous solution was 30 mass %. The temperature of the aqueous nitric acid solution was 80 degrees Celsius.

(5-4) Manufacture of magnetic powder 1D

The magnetic powder 1A was subjected to a heat treatment at a temperature of 400 degrees Celsius for 1 hour in an atmosphere of 100% hydrogen. By this heat treatment, the oxide layer was reduced and removed, and a magnetic powder without the oxide layer was obtained.

Next, an oxide layer was formed by an electrochemical method. The electrochemical method was as follows. NiCl₂, ZnCl, and KCl were mixed at a molar ratio of 1:10:12, heated to 300 degrees Celsius, and melted to prepare a bath. A working electrode was produced by compacting the above magnetic powder without the oxide layer onto a ferrite mesh at a pressure of 1 ton/cm 2. Also, a counter electrode made of glassy carbon and a reference electrode made of Ni were prepared.

The working electrode, the counter electrode, and the reference electrode were immersed in the bath. A predetermined electric potential was applied to the working electrode. The predetermined electric potential was an electric potential of −0.2 V to −0.7 V with respect to the equilibrium potential between dissolution and deposition of Ni/Ni²⁺. As a result, an oxide layer mainly composed of NiO was formed on the magnetic powder contained in the working electrode.

Next, the magnetic powder contained in the working electrode was subjected to a heat treatment in a magnetic field for 1 hour under a constant oxygen concentration. The oxygen concentration was about 0.01 mass %. The strength of the magnetic field was 9 T. The temperature of the heat treatment was 400 degrees Celsius. This heat treatment improved the crystallinity of the oxide layer containing NiO as its main component. In addition, the heat treatment caused an exchange coupling force at the interface between the oxide layer mainly composed of NiO and the L10-FeNi particles.

Through the above steps, the magnetic powder comprising: the main body portion containing the L10-FeNi particles; and the oxide layer formed on the surface of the main body portion was manufactured. Hereinafter, this magnetic powder is referred to as a magnetic powder 1D. The oxide layer included in the magnetic powder 1D was mainly made of NiO.

(5-5) Manufacture of magnetic powder 1E

A magnetic powder 1E was manufactured in basically the same manners as the manufacturing method of the magnetic powder 1D. However, as a method of removing the oxide layer of the magnetic powder 1A, a method of immersing the magnetic powder 1A in an aqueous nitric acid solution for 10 hours was adopted. The concentration of the nitric acid aqueous solution was 30 mass %. The temperature of the aqueous nitric acid solution was 80 degrees Celsius.

(5-6) XRD Measurement of magnetic powder

XRD measurements were performed on respective magnetic powders 1A to 1E. X-rays used in the XRD measurement were kβ rays. In order to confirm the measurement accuracy, a trace amount of Si powder was mixed with the measurement sample.

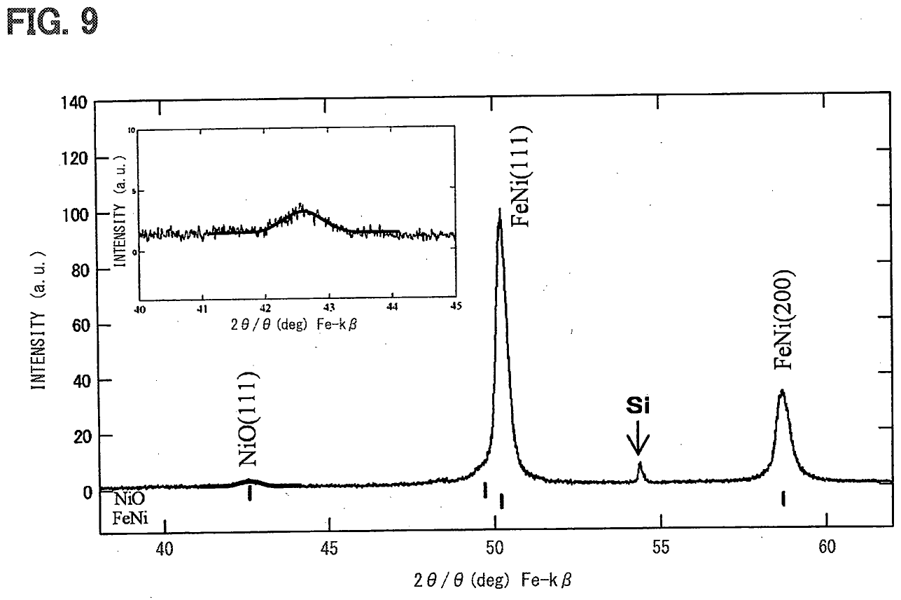

The XRD pattern of the magnetic powder 1D is shown in FIG. 9. This XRD pattern includes a 42.6 degrees peak originating from NiO (hereinafter referred to as NiO (111) peak), a 50.2 peak originating from FeNi, and a 58.7 degrees peak originating from FeNi (hereinafter referred to as FeNi (200) peak) and 54.4 degrees peak originating from Si.

The numerical value on the vertical axis in FIG. 9 is a normalized value obtained by dividing it by the value of the peak area of 50.2 degrees and multiplying by 100. The ratio of the NiO (111) peak area to the FeNi (200) peak area was about 0.02. When analyzed from the ratio of the areas, the mass ratio of FeNi and NiO in the magnetic powder 1D was 94.0: 6.0. If it is assumed that the magnetic powder 1D had an ideal core-shell structure and the core diameter was 500 nm, the thickness of the shell was about 6 nm. The shell corresponds to the oxide layer.

Grounds for the NiO (111) peak being originating from NiO are as follows. According to XRD simulation, if the amount of NiFe₂O₄ is sufficiently large, peaks originating from NiFe₂O₄ are observed at 40.8 degrees, 42.7 degrees, and 49.6 degrees. The peak intensity of 40.8 degrees originating from NiFe₂O₄ is greater than the peak intensity of 42.6 degrees originating from NiFe₂O₄. In the XRD pattern of FIG. 9, no peak is observed at 40.8 degrees. Therefore, the peak at 42.6 degrees is not a peak originating from NiFe₂O₄ but a peak originating from NiO.

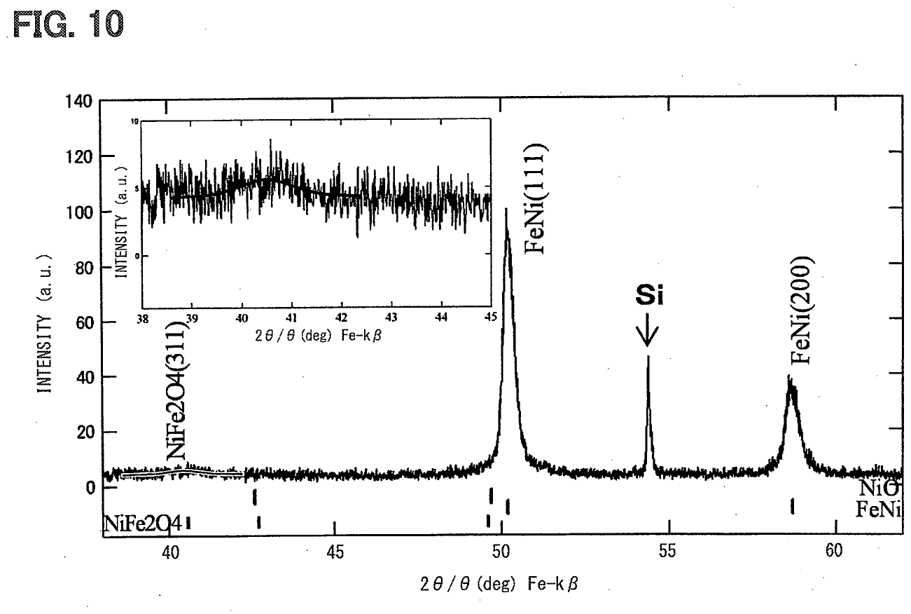

The XRD pattern of the magnetic powder 1A is shown in FIG. 10. Unlike the XRD pattern of FIG. 9, no NiO (111) peak was observed. Further, unlike the XRD pattern of FIG. 9, a 40.8 degrees peak originating from NiFe₂O₄ was observed. This confirmed that the main component of the oxide layer included in the magnetic powder 1A was NiFe₂O₄.

In the magnetic powder 1B, S2 could not be observed. Therefore, the ratio S1/S2 in the magnetic powder 1B was infinite. The ratio S1/S2 in the magnetic powder 1C was 0.8. In the magnetic powder 1D, S2 could not be observed. Therefore, the ratio S1/S2 in the magnetic powder 1D was infinite. The ratio S1/S2 in the magnetic powder 1E was 0.5.

(5-7) Measurement of magnetic property of magnetic powder

For each of the magnetic powders 1A to 1E, the coercivity Hc and the residual magnetization Mr were measured. For the measurement, a small refrigerant-free PPMS VersaLab made by Quantum Design Inc. and a heater option were used. The magnetic field sweep rate was 10 Oe/s. The measurement sample was the magnetic powder itself.

The coercivity of the magnetic powder 1B in the negative external magnetic field was 1.05 times the coercivity of the magnetic powder 1A in the negative external magnetic field. The coercivity of the magnetic powder 1C in the negative external magnetic field was 1.03 times the coercivity of the magnetic powder 1A in the negative external magnetic field. The coercivity of the magnetic powder 1D in the negative external magnetic field was 1.1 times the coercivity of the magnetic powder 1A in the negative external magnetic field. The coercivity of magnetic powder 1E in the negative external magnetic field was 1.08 times the coercivity of magnetic powder 1A in the negative external magnetic field.

### Other Embodiments

Although the embodiments of the present disclosure were illustrated above, the present disclosure is not limited to the above embodiments and can cover various modifications.

(1) A plurality of functions of one constituent element in the above embodiments may be realized by a plurality of constituent elements, or a single function of one constituent element may be realized by a plurality of constituent elements. Further, a plurality of functions of a plurality of constituent elements may be realized by one constituent element, or one function realized by a plurality of constituent elements may be realized by one constituent element. Moreover, a part of a configuration of the embodiments may be omitted. In addition, at least a part of the configuration of the above embodiment may be added to or replaced with the configuration of another embodiment. In addition, all the aspects included in the technical idea specified from the wording described in the claims are embodiments of the present disclosure.

(2) In addition to the above-described magnetic powder and magnet, the present disclosure can be realized in various forms such as a system including the magnet as a constituent element, a magnetic powder manufacturing method, and a magnet manufacturing method.

What is claimed is:

1. A magnetic powder comprising:
a main body portion comprising an L10-FeNi; and
an oxide layer formed on a surface of the main body portion.

2. The magnetic powder according to claim 1, wherein
the oxide layer has a thickness of 5 nm or less.

3. The magnetic powder according to claim 1, wherein
the oxide layer comprises NiₓFe₍₃₋ₓ₎O₄,
where x is greater than or equal to 0 and less than or equal to 3.

4. The magnetic powder according to claim 1, wherein
the oxide layer comprises an antiferromagnetic material.

5. The magnetic powder according to claim 4, wherein
in a measurement result of XRD on the magnetic powder, a peak area originating from the antiferromagnetic material is larger than 0.27 multiplied by a peak area originating from the NiₓFe₍₃₋ₓ₎O₄.

6. The magnetic powder according to claim 4, wherein
an Nail temperature of at least part of the antiferromagnetic material is greater than or equal to 273 K.

7. The magnetic powder according to claim 4, wherein
the antiferromagnetic material is one or more materials selected from the group consisting of NiO, CoO, Cr₂O₃, Fe₂O₃, CuFeS₂, FeF₂, Cr, AuMn, MnPt, MnPd, γFeMn, and γIrMn.

8. The magnetic powder according to claim 4, wherein
the oxide layer has a thickness of 1 nm or more.

9. The magnetic powder according to claim 1, wherein
particle size of the magnetic powder is in a range from 30 nm to 10 μm.

10. A magnet comprising:
a base material; and
the magnetic powder recited in claim 1,
wherein the magnetic powder is dispersed in the base material.

11. The magnet according to claim 10, wherein
the base material comprises a resin,
the magnet further comprising:
an organometallic compound comprising a function group at an interface between the oxide layer and the base material,
wherein X in the following expression is in a range from −0.25 to 0.25,
X=(SP1−SP2)/SP1,
where SP1 denotes an SP value of the resin and SP2 denotes an SP value of the organometallic compound comprising the function group.

12. The magnet according to claim 10, wherein
the base material comprises a resin that has a glass-transition temperature of 100 degrees Celsius or more.

13. The magnet according to claim 11, wherein
the resin is one or more materials selected from the group consisting of epoxy, phenol, polyester, polyimide, and polyamide.
